(19) United States
(12) Patent Application Publication
(10) Pub. No.: US 2024/0007861 A1
(43) Pub. Date: Jan. 4, 2024

(54) METHOD AND APPARATUS FOR PROVIDING SIGNAL INTELLIGENCE AND SECURITY

(71) Applicant: Focal Point Positioning Limited, Cambridge (GB)

(72) Inventors: Ramsey Michael FARAGHER, Cambridge (GB); Robert Mark CROCKETT, Cambridge (GB); Peter James DUFFETT-SMITH, Cambridge (GB)

(21) Appl. No.: 18/216,434

(22) Filed: Jun. 29, 2023

Related U.S. Application Data
(60) Provisional application No. 63/357,277, filed on Jun. 30, 2022.

(51) Int. Cl. H04W 12/122; H04L 9/40

(52) U.S. Cl. CPC H04W 12/122; H04L 63/1483

(57) ABSTRACT

A method, apparatus and system for determining a legitimacy of a signal source for providing signal intelligence and security includes receiving a signal from at least one emitter at an antenna of at least one receiver, determining a motion of the antenna of the at least one receiver, performing motion compensated correlation on the received signal to generate at least one motion compensated correlation result, determining a direction of arrival for the received signal using the motion compensated correlation result, determining a location of the at least one emitter using the direction of arrival of the received signal, and determining the legitimacy for the at least one emitter based on the determined location of the at least one emitter and information regarding locations of legitimate emitters. Additionally, an action affecting the reception of signals from the emitter at the receiver can be performed based on the legitimacy of the emitter.

### CROSS-REFERENCE TO RELATED APPLICATIONS

This application claims benefit of U.S. Provisional Patent Application Ser. No. 63/357,277 filed Jun. 30, 2022, which is herein incorporated by reference in its entirety.

### BACKGROUND

### Field

Embodiments of the present invention generally relate to radio signal transmission and, in particular, to a method, apparatus and system for providing signal intelligence and security information related to one or more radio transmitters.

### Description of the Related Art

Radio transmissions are used in various communications and positioning system. WiFi, Bluetooth and cellular communications transceiver are ubiquitous. Global navigation satellite system (GNSS) receivers are used in nearly every mobile device and require reliable satellite radio transmissions to accurately determine a GNSS receiver's position. Systems using these technologies have become critical to functional infrastructure, communications and to the future of transportation. For example, these systems are instrumental in providing functionality to autonomous vehicles. Accurate position and communications to/from autonomous vehicles is a necessity for the vehicle's operation.

Unfortunately, there are people that aim to thwart the reliable function of systems that rely on radio transmissions by using spoofing transmitters. Such spoofing creates a substantial cybersecurity threat. Spoofing transmitters (aka spoofers) transmit signals that mimic legitimate signals such that the receiver may receive and process the spoofing signal as if it were legitimate. In, for example, a GNSS receiver, a spoofer may generate signals that cause the receiver to provide inaccurate position information. Such spoofing of GNSS receivers can be an annoyance to someone using the signal for guidance or lead to catastrophe for an autonomous vehicle using the signal for vehicle guidance.

Therefore, there is a need for a method, apparatus and system for providing signal intelligence and security for radio transmissions.

### SUMMARY

Embodiments of the present invention generally relate to a method and apparatus for providing signal intelligence and security as shown in and/or described in connection with at least one of the figures.

In some embodiments, a method, apparatus and system for determining a legitimacy of a signal source for providing signal intelligence and security includes receiving a signal from at least one emitter at an antenna of at least one receiver, determining a motion of the respective antenna of the at least one receiver, performing motion compensated correlation on the received signal to generate at least one motion compensated correlation result, determining a direction of arrival for the received signal using the at least one motion compensated correlation result, determining a location of the at least one emitter using the direction of arrival of the received signal, and determining the legitimacy for the at least one emitter based on the determined location of the at least one emitter and information regarding locations of legitimate emitters. Additionally, an action affecting the reception of signals from the emitter at the receiver can be performed based on the determined legitimacy of the emitter.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

So that the manner in which the above recited features of the present invention can be understood in detail, a particular description of the invention, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts a high-level block diagram of a communication environment in which a receiver of the present principles can be implemented in accordance with at least one embodiment of the present principles;

FIG. 2 depicts a high-level block diagram of a receiver of the present principles in accordance with an embodiment of the present principles;

FIG. 3 depicts a graphic representation of the functionality of a receiver of the present principles in accordance with at least one embodiment of the present principles; and

FIG. 4 depicts a flow diagram of a method for determining a legitimacy of a signal source for providing signal intelligence and security in accordance with at least one embodiment of the invention.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

Embodiments of the present principles provide methods, apparatuses and systems for providing signal intelligence and security information for one or more radio transmitters. While the concepts of the present principles are susceptible to various modifications and alternative forms, specific embodiments thereof are shown by way of example in the drawings and are described in detail below. It should be understood that there is no intent to limit the concepts of the present principles to the particular forms disclosed. On the contrary, the intent is to cover all modifications, equivalents, and alternatives consistent with the present principles and the appended claims. For example, although embodiments of the present principles will be described primarily with respect to specific signals originating from specific transmitters and being received by specific receivers, embodiments in accordance with the present principles can be applied to substantially any radio signals originating from substantially any signal source and being received by substantially any receiver.

In the present disclosure, a determination of legitimacy information or a legitimacy of a signal source, such as an emitter, in accordance with the present principles is intended to be understood as determining, assessing, estimating, or inferring the legitimacy of the signal source and/or the received signal, based on determined DoA and location information determined for a signal source. Such determination can be considered as performing legitimacy verification, or a legitimacy check, that is verifying or checking the legitimacy of the signal source or a signal from the signal source.

Digital communications systems such as cellular, Bluetooth or WiFi utilize encoded digital signals to improve communication throughput and security. Most of these systems utilize some form of deterministic digital code to facilitate signal acquisition, e.g., Gold codes, training sequences, synchronization words, channel characterization sequences, or other forms of acquisition codes. GNSS transmissions also utilize repeatedly transmitted acquisition codes. Such a digital code is deterministic by the receiver and repeatedly broadcast by the transmitter to enable the receivers to acquire and receive the transmitted signals. Using such deterministic codes combined with an accurate motion model of a receiver, embodiments of the invention are useful for identifying a direction of arrival (DoA) for a propagation path between the receiver and transmitter. The technique for performing this DoA determination using receiver motion information is known as SUPERCORRELATION™ and is described in commonly assigned U.S. Pat. No. 9,780,829, issued 3 Oct. 2017; U.S. Pat. No. 10,321,430, issued 11 Jun. 2019; U.S. Pat. No. 10,816,672, issued 27 Oct. 2020; US patent publication 2020/0264317, published 20 Aug. 2020; and US patent publication 2020/0319347, published 8 Oct. 2020, which are hereby incorporated herein by reference in their entireties. A receiver of the present principles, described herein, can use this DoA data to determine location information regarding an emitter or emitters proximate the receiver. For example, the DoA data may be used to determine a legitimacy of emitters for which a respective location was determined by comparing determined location information for emitters with received location information of at least legitimate emitters and, in some embodiments, received location of illegitimate/spoofing emitters. In such embodiments, information regarding a location of legitimate and/or illegitimate emitters can be received from at least one of a storage device accessible to a receiver of the present principles and/or a local database.

In some embodiments, a map of the legitimate emitters can be created using determined locations such that, in the future, emitters that are not on the map can be considered illegitimate emitters and/or emitters requiring further investigation. Alternatively or in addition, in some embodiments, signal sources/emitters identified as illegitimate sources/emitters can also be mapped. Upon determination of a legitimacy of at least one emitter, receivers of the present principles can be implemented to take action to, for example, avoid or suppress a reception of signals from emitters identified as illegitimate emitters such that these illegitimate emitters are no longer a threat. In some embodiments, using the illegitimate emitter locations, government authorities can identify and disable these emitters. Alternatively or in addition, in some embodiments of the present principles, upon determination of a legitimacy of at least one emitter, receivers of the present principles can be implemented to take action to, for example, increase a reception of signals from emitters identified as legitimate emitters

In some embodiments, a receiver of the present principles can be transported through an area containing various emitters and can be used to identify signal propagation paths and locations of each nearby emitter. The emitters can be GNSS satellites, cellular signal transceivers, WiFi transceivers, Bluetooth transceivers, and the like. For example, a receiver of the present principles can be carried by a pedestrian through an area. As the receiver traverses the area, it collects DoA data for the emitters that are nearby (i.e., within range of the emitter). The receiver knows its position through the use of a global navigation satellite system (GNSS) receiver and/or an inertial guidance system. From the receiver position and a plurality of DoA vectors (representing direction from receiver to emitter) to a particular emitter, receivers of the present principles compute the location of the emitter relative to the receiver. The relative location can then be translated to a geocoordinate. As emitter locations are computed, a geocoordinate map is produced showing the locations of the emitters. That is, in some embodiments the determined locations of the emitters can then be mapped via application software configured to map emitters in a local area. Alternatively, emitter location and mapping can be performed by moving the receiver using a vehicle on a ground path. In other embodiments, the receiver can be carried by an airborne vehicle—manned or unmanned (e.g., drones, helicopters, airplanes, etc.). The functions of embodiments of receivers of the present principles be embedded into cellular telephones, Internet of Things (IoT) devices, mobile computers, tablets, control systems for autonomous vehicles and the like. Embodiments find use on any moving platform that receives signals that can be correlated with a locally generated signal.

In some embodiments, multiple receivers can be used to receive signals in a coordinated manner. In further embodiments, the receiver(s) can receive signals from multiple types of emitters operating in various frequency bands to facilitate gathering information related to many systems to generate a signal profile for a given area. Some embodiments can perform the signal processing locally on the moving platform. In other embodiments, the emitter information, receiver motion information and receiver location information can be gathered at the moving platform and communicated (wired or wirelessly) to a server for remote processing in real-time or at a later time. In some embodiments, the data is stored and processed when need arises, e.g., when law enforcement requires a traveled path of a particular cell phone or other emitter.

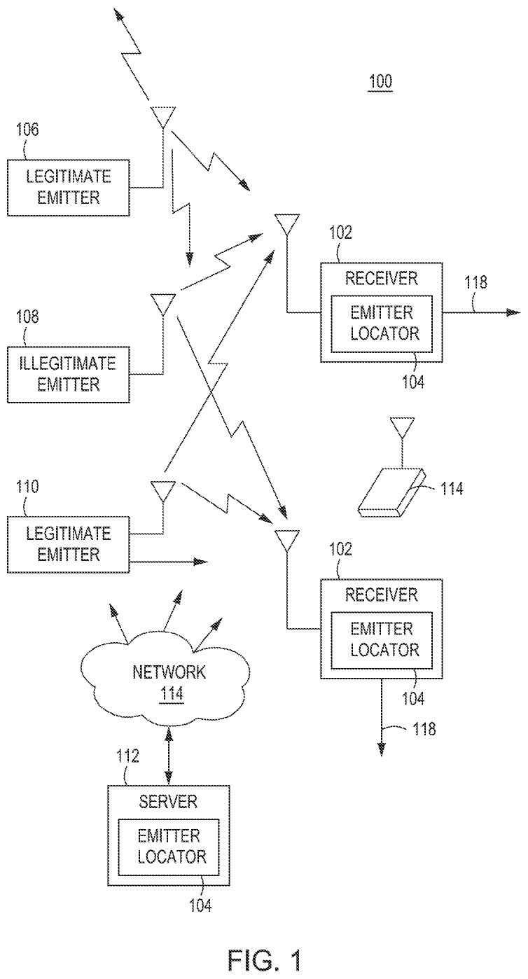

FIG. 1 depicts a high-level block diagram of a communication environment in which a receiver of the present principles can be implemented in accordance with at least one embodiment of the present principles. The communication environment 100 of FIG. 1 illustratively includes one receiver 102 for receiving signals from emitters 106, 108 and 110. In the embodiment 100 of FIG. 1, the emitters 106 and 110 depict legitimate emitters and the emitter 108 depicts an illegitimate emitter (jammer or spoofer). The receiver 102 includes an emitter locator 104 configured to receive and process signals transmitted by emitters 106, 108, 110 (three emitters are depicted, but the receiver 102 may process the signals from any number of emitters). In the embodiment 100 of FIG. 1, the signals from the legitimate emitters 106 and 110 are intended for communication with, a mobile device 114, which can include a cellular telephone, laptop computer, tablets, Internet of Things (IoT) devices, autonomous vehicle, and the like. The mobile device 114 can communicate with the emitters 106, 110 using cellular signals, e.g., CDMA, GSM and the like that support cellular standards such as, but not limited to, 3G, 4G, LTE, and/or 5G standards. Alternatively, or in addition, the legitimate emitters 106, 110 can be WiFi or Bluetooth or other communications devices that communicate amongst themselves or with mobile devices 114. In some embodiments, the legitimate emitters 106, 110 can be satellite-based transmitters of GNSS signals.

In the communication environment 100 of FIG. 1, the illegitimate emitter 108 can target the mobile device 114. That is, the intent of a jammer-type illegitimate emitter 108 is to interfere with reception of transmissions of legitimate emitters 106, 110. A jammer-type illegitimate emitter can transmit signals similar to the legitimate emitter signals to overwhelm or confuse the signal processing capabilities of a target receiver, such as the mobile device 114. A spoofer-type illegitimate emitter, on the other hand, transmits signals that resemble legitimate emitter signals such that the target receiver receives the spoofing signal and even processes the signal as if it were legitimate.

The emitter locator 104 of the receiver 102 can locate both legitimate and illegitimate emitters. In accordance with the present principles, a goal of the emitter locator 104 is to provide signal intelligence for the transmissions occurring in its vicinity. Using the signal intelligence, action can be taken to improve signal security such as to increase reception of legitimate emitters, avoid or suppress reception of illegitimate transmissions from illegitimate emitters, disable illegitimate emitters and the like.

In some embodiments, the emitter locator 104 of the receiver 102 receives and processes the emitter transmissions locally within the receiver. In other embodiments, the emitter locator 104 can collect data regarding emitter transmissions and receiver parameters (e.g., receiver motion, position, etc.). The data can then be communicated or stored for later communication through a communication network 114 to a server 112. In such embodiments, the server 112 can include an emitter locator 104 for processing the data in accordance with the present principles. The data can be processed in real-time or at a later time. In other embodiments, data received can be processed by an emitter locator 104 partially in the local receiver 102 and partially in the server 112.

An emitter locator of the present principles, such as the emitter locator 104 of FIG. 1 (whether receiver-based or server-based) uses a SUPERCORRELATION™ technique as described in commonly assigned U.S. Pat. No. 9,780,829, issued 3 Oct. 2017; U.S. Pat. No. 10,321,430, issued 11 Jun. 2019; U.S. Pat. No. 10,816,672, issued 27 Oct. 2020; US patent publication 2020/0264317, published 20 Aug. 2020; and US patent publication 2020/0319347, published 8 Oct. 2020, which are hereby incorporated herein by reference in their entireties. The technique determines a direction of arrival (DoA) of signals received at a receiver (i.e., received signals) from an emitter 106, 108, 110. As the receiver 102 moves (represented by arrow 118), the emitter locator 104 computes motion information representing motion of the receiver 102. The motion information is used to perform motion compensated correlation of the received signals. From the motion compensated correlation process, the emitter locator 104 estimates the DoA of the received signals. The emitter locator 104 uses the receiver position along with the DoA data to determine a location of the emitters 106, 108, 110. The intersection of a plurality of DoA vectors generated as the receiver moves along path 118 identifies the location of the emitters 106, 108, 110 as described in detail below.

From the determined location of each of the emitters, the receiver 102 or server 112 can create a map of the emitter locations. In one embodiment, the location information can be accumulated within the receiver 102 and downloaded to a mapping application at a later time. In an alternative embodiment, the emitter locations can be continuously, periodically, or intermittently transmitted via cellular or WiFi communications to a server 112 where a mapping application creates a map of the emitter locations.

In alternative embodiments, the received signals can further be processed to determine time of arrival (TOA) or time difference of arrival (TDOA) information for the signals. That is, TOA and TDOA information can be used for position calculations of the emitters. Such calculations can be used to augment the DoA vector processing to improve the speed at which a position solution is attained. Additionally, TOA and/or TDOA information can be used to identify delayed received signals which is indicative of non-line-of-sight (NLOS) signal paths. The DoA vectors associated with NLOS signals can be removed from the emitter location calculation to reduce the amount of computation and/or remove a source of location error.

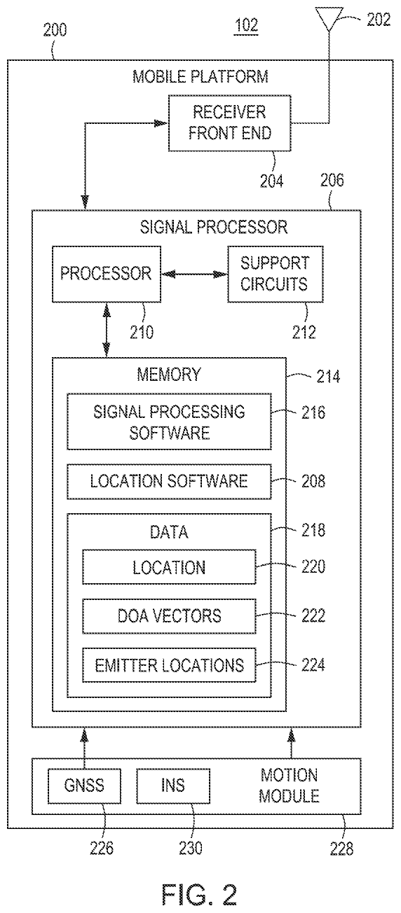

FIG. 2 depicts a high-level block diagram of a receiver of the present principles, such as the receiver 102 of FIG. 1, in accordance with an embodiment of the present principles. The receiver 102 of FIG. 2 illustratively comprises a mobile platform 206, an antenna 202, a receiver front end 204, a signal processor 206, and a motion module 228. In some embodiments, the receiver 102 can comprise a component of a laptop computer, mobile phone, tablet computer, Internet of Things (I) device, unmanned aerial vehicle, mobile computing system in an autonomous vehicle, human operated vehicle, and the like.

In the embodiment of FIG. 2, the receiver 102, the mobile platform 200 and the antenna 202 are an indivisible unit where the antenna 202 moves with the mobile platform 200. The operation of the SUPERCORRELATION™ technique operates based upon determining the motion of the signal receiving antenna. Any mention of motion in the present disclosure refers to the motion of the antenna 202. In some embodiments, the antenna 202 can be separate from the mobile platform 200. In such embodiments, the motion estimate used in the motion compensated correlation process refers to the motion of the antenna 202.

In the embodiment of FIG. 2, the mobile platform 200 comprises a receiver front end 204, a signal processor 206 and a motion module 228. The receiver front end 204 down converts, filters, and samples (digitizes) the received signals. The output of the receiver front end 204 is a digital signal containing data including at least a deterministic training or acquisition code (e.g., a Gold code), that can be used by an emitter to synchronize a transmission to a transceiver.

The signal processor 206 of FIG. 2, illustratively comprises at least one processor 210, support circuits 212 and memory 214. The at least one processor 210 includes any form of processor or combination of processors including, but not limited to, central processing units, microprocessors, microcontrollers, field programmable gate arrays, graphics processing units, digital signal processors, and the like. The support circuits 212 can comprise well-known circuits and devices facilitating functionality of the processor(s). The support circuits 212 can comprise one or more of, or a combination of, power supplies, clock circuits, analog to digital converters, communications circuits, cache, displays, and/or the like.

In the embodiment of FIG. 2, the memory 214 comprises one or more forms of non-transitory computer readable media including one or more of, or any combination of, read-only memory or random-access memory. The memory 214 stores software and data including, for example, signal processing software 216, emitter location software 208 and data 218. The data 218 can include location data 220, such as location information for a receiver or received location information of legitimate and/or illegitimate signal sources (described in greater detail below), direction of arrival (DOA) vectors 222 (collectively, DoA data), determined emitter locations 224, and various data used to perform the SUPERCORRELATION™ processing. The signal processing software 216, when executed by the one or more processors 210, performs signal processing functionality of the present principles including but no limited to, motion compensated correlation upon the received signals to estimate the DoA vectors for the received signals, and comparison of determined signal source locations, determined in accordance with the present principles, to received signal information, such as locations of legitimate and/or illegitimate signal sources, to determined if signal sources are legitimate or illegitimate (both described in greater detail below). In some embodiments of the present principles, the signal processing software 216 can further perform the described functionality of the emitter locator 104 of FIG. 1.

As described below in detail, the DoA vectors 222 and receiver location information are used by the location software 208 to determine the location of each emitter. The data 218 stored in memory 214 can also include signal estimates, correlation results, motion compensation information, motion information, motion and other parameter hypotheses, position information and the like.

The motion module 228 generates a motion estimate for the receiver 102. The motion module 228 can include an inertial navigation system (INS) 230 as well as a global navigation satellite system (GNSS) receiver 226 such as GPS, GLONASS, GALILEO, BEIDOU, etc. The INS 230 can include one or more of, but not limited to, a gyroscope, a magnetometer, an accelerometer, and the like. To facilitate motion compensated correlation, the motion module 228 produces motion information (sometimes referred to as a motion model) comprising at least a velocity of the antenna 202 in the direction of an emitter of interest (i.e., an estimated direction of a source of a received signal). In some embodiments, the motion information can also include estimates of platform orientation or heading including, but not limited to, pitch, roll and yaw of the platform 200/antenna 202. Generally, the receiver 102 can test a plurality of directions and iteratively narrow the search to one or more directions of interest.

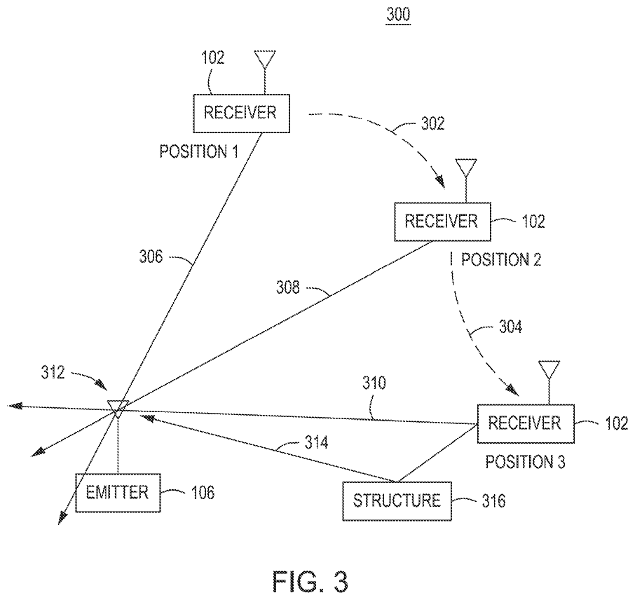

FIG. 3 depicts a graphic representation 300 of the functionality of a receiver of the present principles, such as the receiver 102 of FIGS. 1 and 2, in accordance with at least one embodiment of the present principles. In the embodiment 300 of FIG. 3, the receiver 102 moves from position 1 along path 302 to position 2, and then moves along path 304 to position 3. In the embodiment 300 of FIG. 3, as the receiver 102 traverses the area, the receiver 102 computes a first DoA vector 306 at position 1, a second DoA vector 308 at position 2 and a third DoA vector 310 at position 3. The three DoA vectors 306, 308 and 310 intersect at the location 312, which is determined to be the location of the emitter 106. Although in the embodiment 300 of FIG. 3, three discrete positions are described as locations at which the DoA vectors are computed, in other embodiments of the present principles, the DoA vectors can be computed periodically, intermittently or continuously as the receiver 102 traverses the area. As such, in various embodiments of the present principles more or less vectors can be used to converge the solution onto an accurate emitter location in accordance with the present principles.

As depicted in the embodiment 300 of FIG. 3, in various embodiments, some DoA vectors 306, 308, and 320 can be line-of-sight (LOS) and some DoA vectors 314 can be non-line-of-sight (NLOS). That is, LOS vectors represent signals that are transmitted directly from the emitter 106 to the receiver 102, while NLOS vectors can be reflected from structures 316 in the vicinity of the receiver 102. As more and more DoA vectors are collected and processed, the LOS vectors converge on a particular location (e.g., location 312). In addition, in some embodiments if TOA or TDOA information is available, the information can be used to remove DoA vectors of NLOS paths because the arrival times will be anomalous (delayed) for the NLOS signals versus the LOS signals (i.e., the time information of NLOS signals will contain a delay compared to the LOS signals).

Alternatively or in addition, in some embodiments of the present principles, structures, such as the structure 316 depicted in the embodiment 300 of FIG. 3, can be modeled using, for example, a building model. The building model in conjunction with ray tracing techniques can be used to determine the DoA of reflected signals. That is, in such embodiments of the present principles, a path of the reflected emitter signal is estimated and the reflected signals can be used in the emitter localization calculation of the present principles.

More specifically, in some embodiments a difference in the direction of signal receipt for any two or more signals received can result from a propagation path of one or more of those signals including one or more changes in direction, that is from one or more of those signals having been reflected. In this way, two sufficiently different remote source vectors, corresponding to two different transmission angles, can be obtained, and an intersection location of those vectors calculated, regardless of whether a receiver of the present principles has moved to an extent that enables triangulation of line-of-sight vectors to the signal source (emitter/antenna of a cell base station tower in a cellular network). That is, in some embodiments, by including one or more reflected signals in location determination of signal sources of the present principles, a location of a remote signal source can still be identified even if a receiver of the present principles does not move sufficiently to enable sufficiently precise triangulation based on two line-of-sight signal vectors.

More specifically, in embodiments involving the use of non-line-of-sight signals in spite of the indirect propagation paths, reflection model data can be obtained comprising a geometrical model of a set of structures capable of reflecting signals. Such a model, which can enable the calculation of remote source vectors based on DoAs of reflected signals which can be particularly useful in urban environments. In such embodiments, it can be beneficial to include a predetermined 3D building model, for example, that represents the structures that may obstruct and/or reflect transmissions. Using techniques such as ray tracing, propagation paths through such environments can be modelled in such a way that useful remote source vector information can be inferred even when the only signal received, for instance for a given position along a movement path of a receiver, is one that has been reflected by one or more structures. In some embodiments, the geometrical model can include a set of one or more structures, which can be natural or artificial, for example buildings, landscape, and terrain features. For example, in the vicinity of a receiver of the present principles, a model representing structures within a predetermined radius of, or within a region containing, an estimated or determined location of the receiver at a given time, can be obtained and used to model propagation paths. In some embodiments, the model data can include three-dimensional geometrical data representative of reflective structures and containing sufficient information about their position and/or orientation to enable a propagation path including one or more reflections to be determined.

For NLOS signals a preferential gain can be provided for a signal received by a receiver of the present principles from a first direction in comparison with a signal received from a respective, second direction. In some embodiments, the first direction can be a line-of-sight direction between the receiver and a remote source, such as an emitter/receiver of a cell base station tower in a cellular network, while the respective second direction can be a non-line-of-sight direction. In some embodiments motion compensation is performed in such a way as to provide preferential gain for a signal received along a non-line-of-sight direction, in particular where additional information is available to enable remote source vectors to be identified from such non-line-of-sight signals.

In some embodiments, one or more receivers of the present principles, such as the receiver 102 of FIGS. 1 and 2, can collect emitter signals, LOS and NLOS, from one or more emitters in an environment over a period of time while the receivers are traversing the area. The collected signals can be processed using the emitter localization techniques of the present principles to create a signal profile for the area. In accordance with the present principles, determined DoA data will contain DoA vector intersection regions that identify emitter locations. In some embodiments, a Baysian estimator can be used to compare various hypotheses as to emitter location using information provided by available measurements. Typically, vector intersection location 312 is not a point, but rather a region or area due to the probabilistic nature of the DoA vectors. That is, a determined direction of each vector has an uncertainty caused by measurement error and the intersection forms a region rather than a point. The region will have a maximum that defines the location of the emitter.

In accordance with the present principles, because a receiver of the preset principles knows its position through GNSS and/or INS calculations, the geolocation coordinates of the receiver, using determined DoA information for an emitter can be translated into a geolocation coordinates for location of an emitter(s). As such, a geolocation map of emitter locations can be generated. In various embodiments of the present principles, a receiver can determine locations for many nearby emitters sequentially and/or simultaneously.

It should be noted that in some instances, vector intersection location, such as the emitter location, 312, may not be a point, but rather a region or area due to the probabilistic nature of DoA vectors (i.e., the determined direction of each vector has an uncertainty caused by measurement error and the intersection forms a region rather than a point). In such embodiments, the region of intersection will form a maximum that defines a location of the emitter 106.

In accordance with the present principles, determined location information of signal sources, such as emitters, can be used to determine legitimacy information for the signal sources for which location information was determined. In some embodiments of the present principles, legitimacy information for signal sources, such as emitters, can be obtained, for example, from a remotely hosted database, which can provide information, such as locations of legitimate signal sources. The location of signal sources, such as emitters, determined in accordance with the present principles can be compared to received legitimacy information and specifically in this described embodiment, to the location information for legitimate signal sources, to determine if the signal sources for which location information was determined are legitimate. That is, in such embodiments, location information of signal sources determined in accordance with the present principles, are compared with received location information for legitimate signal sources, and if a determined location of a signal source matches a location of a legitimate signal source in the received information, the signal source can be considered a legitimate signal source. If a determined location of a signal source does not match a location of a legitimate signal source in the received information, the signal source can be considered an illegitimate signal source.

In some embodiments of the present principles, other characteristics of a received signal from a signal source or characteristics of the signal source itself can be used to determine legitimacy information for the signal sources for which location information was determined. For example, in some embodiments, information regarding signal properties, such as a signal type, can be used to determine legitimacy information for the signal sources for which location information was determined. That is, information received regarding a type of signal, for example GNSS, cellular, WiFi, or Bluetooth, that are expected to be received from a legitimate signal source can be used to facilitate the determination as to whether a signal source is legitimate. In such embodiments, signals from a signal source for which location information was determined can be analyzed by, for example, the signal processing software 216 of the receiver 102 of FIGS. 1 and 2, to determine a respective signal type of received signals and the signal type of signals received from the signal sources can be compared to received information regarding expected signal types to be received from legitimate signal sources to determine if a signal source is legitimate and/or illegitimate.

Alternatively or in addition, in some embodiments of the present principles, other characteristics of a received signal from a signal source can be used to determine legitimacy information for the signal sources for which location information was determined. For example, in some embodiments, information regarding angular (i.e., angle of arrival) or positional information of a signal source, such as an emitter, determined from a signal received from a signal source can be compared to received expected properties or angular or positional information for signals received from legitimate signal sources of a given type of signal. Such embodiments can be beneficial for validating signals that are expected to originate from a particular height or at a given azimuthal angle. For example, such embodiments of the present principles can be applied to GNSS signals, which should be typically transmitted from sources higher in position than most receivers, and so, such signals ought to have more steeply inclined DoA and/or remote source vectors. Ground-based spoofing/illegitimate sources, for example, can be identified because signals originating from such sources will have less steeply inclined transmission paths than the expected signals from legitimate signal sources. Accordingly, in such embodiments, when an angle formed by a signal originating from a signal source and a horizontal direction, or alternatively or additionally an angle between the horizontal and the direction of arrival, is smaller than a predefined threshold angle defined by information received regarding signals originating from legitimate signal sources, it can be determined that the signal source is an illegitimate signal source. That is, if the angle that can be calculated based on a signal from a signal source is smaller than expected for a legitimate source, legitimacy information can be generated so that it is indicative of the signal source being illegitimate. In some embodiments, such indication can be made, for example, in the form of a flag or any suitable form of data to indicate the invalid or potentially suspicious signal source.

In some embodiments of the present principles, a threshold angle for a signal from a signal source can be 5 degrees, or in some cases 10, 20, 30, or 40 degrees dependent on a chosen level of discrimination to be applied. In such embodiments, the horizontal direction can be defined as a direction that is orthogonal to the vertical direction and lying in the same vertical plane as the signal source or direction of arrival vector with which the angle is formed. A horizontal direction can also be considered as a direction or vector parallel to the plane of the horizon and lying in the same vertical plane as the vector. Such horizontal and vertical reference vectors or directions can be defined, in some embodiments, with respect to a position of a receiver of the present principles, for instance at the time of reception of the signal from the signal source, or by the location at which a vector collinear with the remote source vector is incident upon the surface of the earth. The vertical reference direction can be defined as a direction parallel to the direction of gravity experienced at the point on the surface of the earth or at the location of the receiver.

In embodiments in which a threshold angle is used to determine that a signal source is legitimate or illegitimate, as described above, the threshold angle used for either of these determinations can be the same but are typically different. For example, a first threshold angle, below which signal sources can be determined to be illegitimate, is smaller than a second threshold angle, above which sources can be determined to be legitimate. In some embodiments, a difference between the two threshold angles can be, for example, 5, 10, or 15 degrees. As such, three ranges of azimuthal angles can be defined as, above, below, and between the two threshold angles, and the obtaining of legitimacy information may be performed by comparing the remote source vector to these ranges. In some embodiments, if a signal ostensibly originates from a satellite, remote source vectors in the shallowest of the three ranges can be an indicator that the source is illegitimate, a remote source vector in the highest of the three angle ranges can cause the signal source to be deemed legitimate, while the third, intermediate range can correspond to the signal source being classified or indicated to be potentially legitimate, for instance being flagged as such so that further investigation as to that signal source can be performed.

In some embodiments, instead of identifying a signal source as a legitimate or illegitimate signal source, a signal source can be given a score based on, for example, how similar a characteristic of a received signal from a signal source is to the same characteristic of a legitimate signal source. For example, in some embodiments, a signal source that has a determined location close to an identified location of a legitimate signal source can be given a higher score than a signal source that has a determined location that is far from the identified location of the legitimate signal source. In such embodiments, a signal source can be identified as legitimate or illegitimate based on whether a score determined for the signal source is above or below a threshold value.

Once legitimacy information has been determined for at least one signal source in accordance with the present principles, action can be taken regarding signal sources that are determined to be legitimate, illegitimate, or potentially illegitimate. In some embodiments, such action can include investigating, blocking, or disabling signals from illegitimate signal sources, such as emitters/transmitters and/or to increase reception of signals from emitters determined to be legitimate.

For example, in embodiments in which a signal source/emitter is determined to be illegitimate in accordance with the present principles, a receiver of the present principles can take action including at least one of adjusting an antenna pattern of the antenna of the receiver to decrease a reception quality of signals from the signal source/emitter determined to be illegitimate at the subject receiver, adjusting a time of reception of the antenna of the subject receiver to prevent the antenna from receiving signals during a time of transmission of the signal source/emitter determined to be illegitimate, or communicating a command to the signal source/emitter determined to be illegitimate to cause the signal source/emitter to perform an action to decrease a reception quality of the signal of the signal source/emitter determined to be illegitimate at the subject receiver. For example, in some embodiments a receiver of the present principles, such as the receiver 102 of FIGS. 1 and 2, can be configured such that any signals from a signal source identified to be illegitimate are excluded from any processing that the receiver is configured to perform. For example, in some embodiments any signals received from a GNSS signal source that has been identified as illegitimate can be excluded from positioning calculations.

In some embodiments of the present principles, adjusting an antenna pattern of the antenna of the receiver includes at least one of beam steering a main sensitivity lobe of the antenna pattern of the antenna away from a determined direction of arrival of the signal from the signal source/emitter determined to be illegitimate, or steering a null of the antenna pattern of the antenna in the determined direction of arrival of the signal from the signal source/emitter determined to be illegitimate. In some embodiments of the present principles, communicating a command to the signal source/emitter determined to be illegitimate to cause the signal source/emitter determined to be illegitimate to perform an action to decrease a reception quality of the signal from the signal source/emitter determined to be illegitimate at the receiver includes at least one of communicating a command to the signal source/emitter determined to be illegitimate to adjust an antenna pattern of a transmission antenna of the signal source/emitter determined to be illegitimate to steer a transmission of the signal from the signal source/emitter determined to be illegitimate away from the antenna of the receiver, or communicating a command to the signal source/emitter determined to be illegitimate to steer a null of the antenna pattern of the transmission antenna of the signal source/emitter determined to be illegitimate in the direction of the antenna of the subject receiver.

Alternatively or in addition, in embodiments in which a signal source/emitter is determined to be legitimate in accordance with the present principles, a receiver of the present principles can take action to increase/strengthen a reception of signals from a signal source/emitter determined to be legitimate. In some embodiments, such action taken by a receiver of the present principles can include at least one of adjusting an antenna pattern of the antenna of the receiver to increase/strengthen a reception quality of signals from the signal source/emitter determined to be legitimate at the subject receiver, adjusting a time of reception of the antenna of the subject receiver to ensure that the antenna is receiving signals during a time of transmission of the signal source/emitter determined to be legitimate, or communicating a command to the signal source/emitter determined to be legitimate to cause the signal source/emitter to perform an action to increase/strengthen a reception quality of the signal of the signal source/emitter determined to be legitimate at the subject receiver.

In some embodiments of the present principles, adjusting an antenna pattern of the antenna of the receiver to increase a reception strength/quality of the signal from a signal source/emitter determined to be legitimate at the receiver includes at least one of beam steering a main sensitivity lobe of an antenna pattern of the antenna of the receiver toward a determined DoA of the signal from the signal source/emitter determined to be legitimate, or steering a null of the antenna pattern of the antenna away from the determined DoA from the signal source/emitter determined to be legitimate. In some embodiments of the present principles, communicating a command to the signal source/emitter determined to be legitimate to cause the signal source/emitter determined to be legitimate to take/perform an action to increase a reception quality of the signal from the signal source/emitter determined to be legitimate at the subject receiver includes at least one of communicating a command to the signal source/emitter determined to be legitimate to adjust an antenna pattern of a transmission antenna of the signal source/emitter to steer a transmission of the signals from the signal source/emitter determined to be legitimate toward the antenna of the receiver, or communicating a command to the signal source/emitter determined to be legitimate to steer a null of the antenna pattern of the transmission antenna of the signal source/emitter away from the direction of the antenna of the receiver.

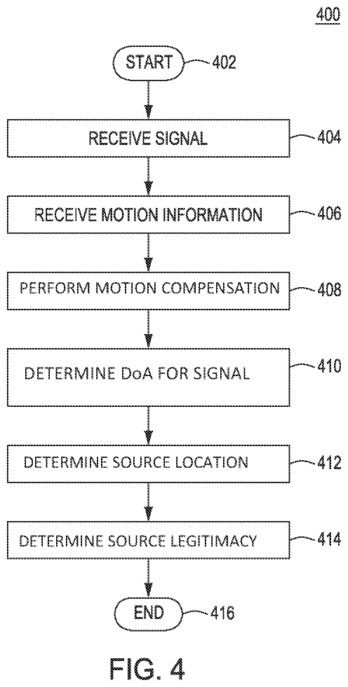

FIG. 4 depicts a flow diagram of a method 400 for determining legitimacy information for at least one signal source, such as an emitter, using at least location information determined for the at least one signal source in accordance with an embodiment of the present principles. In some embodiments, the method 400 can be implemented using signal processing software of a signal process of the present principles, such as the signal processing software 216 of the signal processor 206 of FIG. 2.

The method 400 can begin at 402 and proceed to 404 during which at least one signal from at least one emitter is received at an antenna of at least one receiver. As described above, in some embodiments, signals can be received from at least one remote signal source (e.g., transmitters such as the emitters 106, 108, 110 of FIG. 1) in a manner as described with respect to FIG. 1. Each received signal can include a synchronization or acquisition code, e.g., a Gold code, which can be extracted from the radio frequency (RF) signal received at the antenna of the receiver. The method 400 can proceed to 406.

At 406, a motion of a respective antenna of the at least one receiver that received the at least one signal from the at least one emitter is determined. For example, in some embodiments, the receiver uses a single local oscillator for receiving emitter signals and for receiving GNSS signals. In such embodiments, prior to processing the emitter signals, the SUPERCORRELATION™ technique can applied to the GNSS signals to facilitate improved position accuracy and to correct local oscillator instability. Consequently, the receiver position is very accurate and the local oscillator is stable over long periods such that very long coherent integration times (e.g., 1 second) can be used in processing the GNSS signals and the emitter signals. A motion of a receiver antenna can be determined from, for example, the GNSS signals. The method 400 can proceed to 408.

At 408, motion compensated correlation is performed on the at least one signal received from the at least one emitter using the motion information determined for the respective antenna of the at least one receiver to generate at least one motion compensated correlation result. In some embodiments of the present principles, the motion compensation correlation includes correlating at least one local signal with the at least one signal from the at least one cellular emitter to generate at least one respective correlation result, generating a plurality of phasor sequences, where each phasor sequence represents a hypothesis comprising a sequence of signal phases related to a relative direction of motion of the relative antenna of the at least one receiver, compensating at least one phase of at least one of the local signal, the at least one signal of the at least one cellular emitter or the at least one correlation result, based on the generated plurality of phasor sequences, to determine at least one phase-compensated correlation result, and identifying a phasor sequence in the plurality of phasor sequences that optimizes the at least one motion compensated correlation result.

That is, in accordance with embodiments of the present principles, to perform motion compensated correlation a plurality of phasor sequence hypotheses related to a direction of interest of the received signal (i.e., direction toward an emitter) can be generated. Each phasor sequence hypothesis comprises a time series of phase offset estimates that vary with parameters such as receiver motion, frequency, DoA of the received signals, and the like. The signal processing correlates a local code encoded in a local signal with the same code encoded within the received RF signal. In one embodiment, the phasor sequence hypotheses are used to adjust, at a sub-wavelength accuracy, the carrier phase of the local signal. In some embodiments, such adjustment or compensation can be performed by adjusting a local oscillator signal, the received signal(s), or the correlation result to produce a phase compensated correlation result. The signals and/or correlation results are complex signals comprising in-phase (I) and quadrature phase (Q) components. The method applies each phase offset in the phasor sequence to a corresponding complex sample in the signals or correlation results. If the phase adjustment includes an adjustment for a component of receiver motion in an estimated direction of the emitter, then the result is a motion compensated correlation result. For each received signal, the received signals are correlated with a set (plurality) of direction hypotheses containing estimates of the phase offset sequences necessary to accurately correlate the received signals over a long coherent integration period (e.g., 1 second). There is a set of hypotheses representing a search space for each received signal.

The motion estimates are typically hypotheses of the receiver motion in a direction of interest such as in the direction of the emitter that transmitted the received signal. At initialization, the direction of interest can be unknown or inaccurately estimated. Consequently, a brute force search technique may be used to identify one or more directions of interest by searching over all directions and correlating signals received in all directions. A comparison of correlation results over all the directions enables a narrowing of the search space. There is very strong correlation between the true values of these hypotheses between code repetition, such that the initial search might be intensive, but subsequent processing only requires tracking of the parameters in the receiver as they evolve. Consequently, subsequent compensation is performed over a narrow search space.

In one embodiment, if a signal from a given emitter was received previously, the set of hypotheses for the newly received signal include a group of phasor sequence hypotheses using the expected Doppler and Doppler rate and/or last Doppler and last Doppler rate used in receiving the prior signal from that particular emitter. The values can be centered around the last values used or the last values used additionally offset by a prediction of further offset based on the expected receiver motion. Each received signal can be correlated with that signal's set of hypotheses. The hypotheses are used as parameters to form the phase-compensated phasors to phase compensate the correlation process. As such, the phase compensation can be applied to the received signals, the local frequency source (e.g., an oscillator), or the correlation result values. In addition to searching over the DoA, the hypotheses can be applied to other variables (parameters) such as oscillator frequency to correct frequency and/or phase drift (if not previously corrected) or heading to ensure the correct motion compensation is being applied. The number of hypotheses may not be the same for each variable. For example, the search space can contain ten hypotheses for searching DoA and have two hypotheses for searching a receiver motion parameter such as velocity—i.e. a total of twenty hypotheses (ten multiplied by two). The result of the correlation process is a plurality of phase-compensated correlation results—one phase-compensated correlation result value for each hypothesis for each received signal.

The correlation results can then be analyzed to find a “best” or optimal result for each received signal. The correlation output can be a single value that represents the parameter hypotheses (preferred hypotheses) that provide an optimal or best correlation output. In general, a cost function can be applied to the correlation values for each received signal to find the optimal correlation output corresponding to a preferred hypothesis or hypotheses, e.g., a maximum correlation value is associated with the preferred hypothesis. The method 400 can proceed to 410.

At 410, a direction of arrival for the at least one signal from the at least one emitter is determined using the generated phase-compensated correlation result. In some embodiments, the DoA vector of each received signal is identified from the optimal correlation result for the signal. That is, the received signals along the DoA vector typically have the strongest signal to noise ratio and represent line of sight (LOS) reception between the emitter and receiver. As such, using motion compensated correlation enables receivers of the present principles, such as the receiver 102 of FIGS. 1 and 2, to identify the DoA vectors of received signal(s).

In some embodiments of the present principles, rather than using the largest magnitude correlation value, other test criteria can be used. For example, the progression of correlations can be monitored as hypotheses are tested and a cost function can be applied that indicates the best hypotheses when the cost function reaches a minimum (e.g., a small hamming distance amongst peaks in the correlation plots). In other embodiments, additional hypotheses can be tested in addition to the DoA hypotheses to, for example, ensure the motion compensation (i.e., speed and heading) is correct. The method 400 can proceed to 412.

At 412, a location of the at least one emitter is determined using the direction of arrival determined for the at least one signal from the at least one emitter and a known position of the at least one receiver. That is, in embodiments of the present principles, the location of the at least one emitter is determined relative to a location of the receiver using DoA information determined for respective signals received from the at least one emitter. The method 400 can proceed to 414.

At 414, a legitimacy for the at least one signal source is determined based on the determined location of the at least one signal source/emitter and received information regarding locations of legitimate signal sources/emitters. For example, in some embodiments and as described above, legitimacy information for signal sources, such as emitters, can be obtained, for example, from a remotely hosted database, which can provide information, such as locations of legitimate signal sources. The location of signal sources, such as emitters, determined in accordance with the present principles can be compared to received legitimacy information and specifically in this described embodiment, to the location information for legitimate signal sources, to determine if the signal sources for which location information was determined are legitimate. That is, in such embodiments, location information of signal sources determined in accordance with the present principles, are compared with received location information for legitimate signal sources, and if a determined location of a signal source matches a location of a legitimate signal source in the received information, the signal source can be considered a legitimate signal source. If a determined location of a signal source does not match a location of a legitimate signal source in the received information, the signal source can be considered an illegitimate signal source. The method 400 can then be exited at 416.

In some embodiments of the present principles, the method 400 can further include, performing an action to affect a reception of signals from at least one emitter at the at least one receiver based on the determined legitimacy of the at least one emitter. For example, in some embodiments and as described above, a receiver of the present principles, such as the receiver 102 of FIGS. 1 and 2 can take action to affect a reception of signals from a signal source, such as an emitter, at the receiver 102 based on the determined legitimacy of the signal source/emitter. For example, in some embodiments and as described above, if a signal source is determined to be legitimate, a receiver of the present principles can perform an action including at least one of adjusting an antenna pattern of the respective antenna of the at least one receiver to increase a reception quality of the signals from the at least one emitter at the at least one receiver, adjusting a time of reception of the respective antenna of the at least one receiver to configure the respective antenna to receive signals during a time of transmission of the signals from the at least one emitter, or communicating a command to the at least one emitter to cause the at least one emitter to perform an action to increase a reception quality of the signals from the at least one emitter at the at least one receiver.

Alternatively or in addition, in some embodiments and as described above, if a signal source is determined to be illegitimate, the receiver 102 can perform an action including at least one of adjusting an antenna pattern of the respective antenna of the at least one receiver to decrease a reception quality of the signals from the at least one emitter at the at least one receiver, adjusting a time of reception of the respective antenna of the at least one receiver to prevent the respective antenna from receiving signals during a time of transmission of the signals from the at least one emitter, or communicating a command to the at least one emitter to cause the at least one emitter to perform an action to decrease a reception quality of the signals from the at least one emitter at the at least one receiver.

In some embodiments of the present principles, the method 400 can further include determining the legitimacy for the at least one emitter further based on at least one signal characteristic of the at least one signal from the at least one emitter received at the respective antenna of the at least one receiver, wherein the at least one signal characteristic can include at least one of a signal type of the at least one signal, an angle of arrival of the at least one signal, or positional information of the at least one signal.

In some embodiments of the present principles, the method 400 can further include determining at least one of time of arrival (TOA) or time difference of arrival (TDOA) information for the at least one signal from the at least one emitter for assisting in the determination of the location of the at least one emitter.

In some embodiments, the processes/methods of the present principles can be iterative as additional DoA vectors are generated or can be calculated when a predefined number (e.g., three, five, ten, etc.) of DoA vectors have been determined.

In such embodiments, the position computation can be augmented using TOA or TDOA information. For example, the time information related to the time a signal is received at various receiver positions can be used to identify LOS signals versus NLOS signals (e.g., NLOS signals have a delayed reception time as compared to LOS signals). DoA vectors associated with NLOS signals can then be removed from the vector set used to determine emitter location.

In some embodiments, the method can further include computing geolocation coordinates for the emitter location by translating the known geolocation coordinates of the receiver to the emitter location determined. That is, the location information for signal sources determined in accordance with the present principles includes data that can be used to derive, a geospatial coordinate, that is, data representing a position, or one or more components thereof, of the signal source, such as an emitter/antenna of a cell base station tower in a cellular network with respect to a geographic reference frame or coordinate system. Embodiments of the present principles can update a map or database with the geolocation of signal sources, such as emitters/antennas, which can also lead to the location of base stations of a cell base station tower in a cellular network, such that a comprehensive list of signal sources is created. This is advantageous as it enables more exact and accurate location data to be provided for such network elements, which again can include fixed transceiver base stations. The locations of such elements are typically known with considerably less precision.

In some embodiments, a method of the present principles can query whether another set of DoA vectors for another emitter are available for processing and repeat the process.

Embodiments of the present principles can be used to collect emitter data over time without processing the data (i.e., the emitter and receiver data is stored for subsequent processing on an as needed basis). For example, an autonomous vehicle can collect and store emitter and receiver data that can be processed after a traffic accident has occurred. The processing can indicate that a GNSS spoofing emitter may have caused the vehicle's GNSS receiver to malfunction and follow an incorrect path.

Embodiments of the present principles can be used to process collected cellular telephone data where the cellular telephone is the emitter of interest and police cars with embodiments of receivers described above collect emitter data for subsequent processing. Upon a need arising, emitter data from receivers known to be in the area of a crime can be processed to determine a particular cellular telephone's movement over a particular period. Such movement evidence can form useful evidence in an investigation. In some embodiments, to simplify the signal processing, the receiver data is processed at points at which the emitter is stationary (e.g., at traffic lights or stop signs) and the path can be interpolated between the stationary points.

In some embodiments, a receiver and emitter locator of the present principles, such as the receiver 102 of FIGS. 1 and 2 and the emitter locator 104, can be a feature of a mobile device such that, once an illegitimate emitter is found, the mobile device can use the emitter's location to take action to suppress signals arriving from the emitters DoA. Such action can involve altering an antenna pattern of the mobile device or can involve using the SUPERCORRELATION™ technique to suppress reception of signals from the emitter's location. Alternatively or in addition, in accordance with the present principles, a receiver and emitter locator of the present principles can enhance reception of signals from signal sources/emitters determined to be legitimate.

In an embodiment of the present principles, a method for determining a legitimacy of at least one emitter includes determining a motion of a respective antenna of at least one receiver that received at least one signal from at least one emitter, using the determined antenna motion, performing motion compensated correlation on the at least one received signal to generate at least one motion compensated correlation result, and determining a direction of arrival for the at least one received signal using the at least one motion compensated correlation result. In some embodiments, information derived from the direction of arrival determined for the at least one signal of the at least one emitter can be used to determine if an emitter is legitimate. For example, in some embodiments, a receiver of the present principles can be provided information regarding locations of legitimate emitters and from such information a receiver of the present principles can determine at what angle or from what direction signals from legitimate receivers should be received. In such embodiments, a receiver of the present principles can use the direction of arrival information determined for the at least one signal of the at least one emitter to determined if signals being received from the at least one emitter have an angle or are coming from a location consistent with a legitimate receiver. If so, the respective emitter can be considered legitimate. If not, the respective emitter can be considered illegitimate or possibly illegitimate.

In some embodiments a method of obtaining legitimacy information for a remote source includes receiving, at a receiver, a signal from the remote source in a first direction, providing a local signal, determining a movement of the receive, providing a correlation signal by correlating the local signal with the received signal, providing motion compensation of at least one of the local signal, the received signal, and the correlation signal, based on the determined movement in the respective first direction to provide preferential gain for a signal received along the respective first direction, identifying, based on the said correlation, a remote source vector corresponding to a portion of a propagation path of the received signal, the portion being coincident with the remote source, and generating the legitimacy information for the remote source in accordance with the remote source vector of the received signal.

In such embodiments, the legitimacy information can be generated in accordance with a signal type of the received signal. In such embodiments, when an angle formed by the remote source vector and a horizontal direction is smaller than a predetermined threshold angle, the legitimacy information can be generated to indicate that the remote source is an illegitimate source. In such embodiments, when an angle formed by the remote source vector and a horizontal direction is greater than a predetermined threshold angle, the legitimacy information can be generated to indicate that the remote source is a legitimate source.

In some embodiments of the present principles, a method for determining legitimacy information for at least one source includes, for each of a plurality of signals received at the receiver from the remote source, each of the signals being received in a respective first direction, providing a respective local signal, determining a respective movement of the receiver, providing a respective correlation signal by correlating the respective local signal with the received signal, providing motion compensation of at least one of the respective local signal, the received signal, and the respective correlation signal, based on the respective determined movement in the respective first direction to provide preferential gain for a signal received along the respective first direction, and identifying, based on the said correlation, a respective remote source vector corresponding to a portion of a propagation path of the received signal, the portion being coincident with the remote source.

In such embodiments, location information for the remote source can be generated by identifying one or more locations at which two or more of the respective remote source vectors of the plurality of received signals intersect, wherein the legitimacy information is generated in accordance with the location information. In such embodiments, the generating of the legitimacy information in accordance with the location information can include obtaining reference location data indicative of one or more legitimate signal sources and generating the legitimacy information based on a comparison between the generated location information and the reference location data.

In some embodiments, the method can further include obtaining reference geographic data corresponding to one or more geographic regions and including information indicating an expected presence of legitimate sources therein, and generating the legitimacy information in accordance with the generated location information and the reference geographic data. In such embodiments, the reference geographic data includes expected source type information corresponding to the one or more geographic regions, and the legitimacy information is generated in accordance with a comparison between the source type information and an identified type of one or more of the plurality of received signals.

In an embodiment of the present principles, a system for determining a legitimacy of at least one emitter includes a local signal generator, configured to provide a local signal, a receiver configured to receive a signal from a remote source in a first direction, a motion module configured to provide a determined movement of the receiver, a correlation unit configured to provide a correlation signal by correlating the local signal with the received signal, a motion compensation unit configured to provide motion compensation of at least one of the local signal, the received signal, and the correlation signal based on the determined movement in the first direction, a source vector unit configured to identify, based on the correlation, a remote source vector corresponding to a portion of a propagation path of the received signal that is coincident with the remote source and a legitimacy information unit configured to generate legitimacy information in accordance with a remote source vector of a received signal.

In some embodiments the system is configured to receive, at the receiver, a signal from the remote source in a first direction, provide a local signal using the local signal generator, determine a movement of the receiver using the motion module, using a correlation unit, provide a correlation signal by correlating the local signal with the received signal, provide motion compensation of at least one of the local signal, the received signal, and the correlation signal, based on the determined movement in the respective first direction to provide preferential gain for a signal received along the respective first direction using the motion compensation unit, identify, based on the said correlation, a remote source vector corresponding to a portion of a propagation path of the received signal, the portion being coincident with the remote source using the source vector unit, and generate the legitimacy information for the remote source in accordance with the remote source vector of the received signal using the legitimacy information unit.

The methods and processes described herein may be implemented in software, hardware, or a combination thereof, in different embodiments. In addition, the order of methods can be changed, and various elements can be added, reordered, combined, omitted or otherwise modified. All examples described herein are presented in a non-limiting manner. Various modifications and changes can be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances can be provided for components described herein as a single instance. Boundaries between various components, operations and data stores are somewhat arbitrary, and particular operations are illustrated in the context of specific illustrative configurations. Other allocations of functionality are envisioned and can fall within the scope of claims that follow. Structures and functionality presented as discrete components in the example configurations can be implemented as a combined structure or component. These and other variations, modifications, additions, and improvements can fall within the scope of embodiments as defined in the claims that follow.

Those skilled in the art will also appreciate that, while various items are illustrated as being stored in memory or on storage while being used, these items or portions of them can be transferred between memory and other storage devices for purposes of memory management and data integrity. Alternatively, in other embodiments some or all of the software components can execute in memory on another device and communicate with a computing device via inter-computer communication. Some or all of the system components or data structures can also be stored (e.g., as instructions or structured data) on a computer-accessible medium or a portable article to be read by an appropriate drive, various examples of which are described above. In some embodiments, instructions stored on a computer-accessible medium separate from the computing device can be transmitted to the computing device via transmission media or signals such as electrical, electromagnetic, or digital signals, conveyed via a communication medium such as a network and/or a wireless link. Various embodiments can further include receiving, sending or storing instructions and/or data implemented in accordance with the foregoing description upon a computer-accessible medium or via a communication medium. In general, a computer-accessible medium can include a storage medium or memory medium such as magnetic or optical media, e.g., disk or DVD/CD-ROM, volatile or non-volatile media such as RAM (e.g., SDRAM, DDR, RDRAM, SRAM, and the like), ROM, and the like.

In the foregoing description, numerous specific details, examples, and scenarios are set forth in order to provide a more thorough understanding of the present disclosure. It will be appreciated, however, that embodiments of the disclosure can be practiced without such specific details. Further, such examples and scenarios are provided for illustration, and are not intended to limit the disclosure in any way. Those of ordinary skill in the art, with the included descriptions, should be able to implement appropriate functionality without undue experimentation.

References in the specification to “an embodiment,” etc., indicate that the embodiment described can include a particular feature, structure, or characteristic, but every embodiment may not necessarily include the particular feature, structure, or characteristic. Such phrases are not necessarily referring to the same embodiment. Further, when a particular feature, structure, or characteristic is described in connection with an embodiment, it is believed to be within the knowledge of one skilled in the art to affect such feature, structure, or characteristic in connection with other embodiments whether or not explicitly indicated.

Embodiments in accordance with the disclosure can be implemented in hardware, firmware, software, or any combination thereof. Embodiments can also be implemented as instructions stored using one or more machine-readable media, which may be read and executed by one or more processors. A machine-readable medium can include any mechanism for storing or transmitting information in a form readable by a machine (e.g., a computing device or a “virtual machine” running on one or more computing devices). For example, a machine-readable medium can include any suitable form of volatile or non-volatile memory.

In addition, the various operations, processes, and methods disclosed herein can be embodied in a machine-readable medium and/or a machine accessible medium/storage device compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium/storage device.

Modules, data structures, and the like defined herein are defined as such for ease of discussion and are not intended to imply that any specific implementation details are required. For example, any of the described modules and/or data structures can be combined or divided into sub-modules, sub-processes or other units of computer code or data as can be required by a particular design or implementation.

In the drawings, specific arrangements or orderings of schematic elements can be shown for ease of description. However, the specific ordering or arrangement of such elements is not meant to imply that a particular order or sequence of processing, or separation of processes, is required in all embodiments. In general, schematic elements used to represent instruction blocks or modules can be implemented using any suitable form of machine-readable instruction, and each such instruction can be implemented using any suitable programming language, library, application-programming interface (API), and/or other software development tools or frameworks. Similarly, schematic elements used to represent data or information can be implemented using any suitable electronic arrangement or data structure. Further, some connections, relationships or associations between elements can be simplified or not shown in the drawings so as not to obscure the disclosure.

This disclosure is to be considered as exemplary and not restrictive in character, and all changes and modifications that come within the guidelines of the disclosure are desired to be protected.

Any block, step, module, or otherwise described herein may represent one or more instructions which can be stored on non-transitory computer readable media as software and/or performed by hardware. Any such block, module, step, or otherwise can be performed by various software and/or hardware combinations in a manner which may be automated, including the use of specialized hardware designed to achieve such a purpose. As above, any number of blocks, steps, or modules may be performed in any order or not at all, including substantially simultaneously, i.e., within tolerances of the systems executing the block, step, or module.

Where conditional language is used, including, but not limited to, “can,” “could,” “may” or “might,” it should be understood that the associated features or elements are not required. As such, where conditional language is used, the elements and/or features should be understood as being optionally present in at least some examples, and not necessarily conditioned upon anything, unless otherwise specified.

Where lists are enumerated in the alternative or conjunctive (e.g., one or more of A, B, and/or C), unless stated otherwise, it is understood to include one or more of each element, including any one or more combinations of any number of the enumerated elements (e.g. A, AB, AC, ABC, ABB, etc.). When “and/or” is used, it should be understood that the elements may be joined in the alternative or conjunctive.

While the foregoing is directed to embodiments of the present principles, other and further embodiments of the present principles may be devised without departing from the basic scope thereof, and the scope thereof is determined by the claims that follow.

1. A method for determining a legitimacy of at least one emitter, comprising:
receiving at least one signal from the at least one emitter at a respective antenna of at least one receiver;
determining a motion of the respective antenna of the at least one receiver that received the at least one signal from the at least one emitter;
using the determined antenna motion, performing motion compensated correlation on the at least one received signal to generate at least one motion compensated correlation result;
determining a direction of arrival for the at least one received signal using the at least one motion compensated correlation result;
determining a location of the at least one emitter using the direction of arrival of the at least one received signal and a known location of the at least one receiver; and
determining the legitimacy for the at least one emitter based on the determined location of the at least one emitter and received information regarding locations of legitimate emitters.

2. The method of claim 1, further comprising:
performing an action to affect a reception of signals from the at least one emitter at the at least one receiver based on the determined legitimacy of the at least one emitter.

3. The method of claim 2, wherein the at least one emitter is determined to be legitimate and wherein the performed action comprises at least one of adjusting an antenna pattern of the respective antenna of the at least one receiver to increase a reception quality of the signals from the at least one emitter at the at least one receiver, adjusting a time of reception of the respective antenna of the at least one receiver to configure the respective antenna to receive signals during a time of transmission of the signals from the at least one emitter, or communicating a command to the at least one emitter to cause the at least one emitter to perform an action to increase a reception quality of the signals from the at least one emitter at the at least one receiver.

4. The method of claim 2, wherein the at least one emitter is determined to be illegitimate and wherein the performed action comprises at least one of adjusting an antenna pattern of the respective antenna of the at least one receiver to decrease a reception quality of the signals from the at least one emitter at the at least one receiver, adjusting a time of reception of the respective antenna of the at least one receiver to prevent the respective antenna from receiving signals during a time of transmission of the signals from the at least one emitter, or communicating a command to the at least one emitter to cause the at least one emitter to perform an action to decrease a reception quality of the signals from the at least one emitter at the at least one receiver.

5. The method of claim 1, wherein the determination of the legitimacy for the at least one emitter is further based on at least one characteristic of at least one of the at least one signal from the at least one emitter received at the respective antenna of the at least one receiver or the at least one emitter.

6. The method of claim 5, wherein the at least one characteristic comprises at least one of a signal type of the at least one signal, an angle of arrival of the at least one signal, or positional information of the at least one emitter.

7. The method of claim 1, wherein performing motion compensated correlation comprises:
correlating at least one local signal with the at least one signal from the at least one cellular emitter to generate at least one respective correlation result;
generating a plurality of phasor sequences, where each phasor sequence represents a hypothesis comprising a sequence of signal phases related to a relative direction of motion of the relative antenna of the at least one receiver;
compensating at least one phase of at least one of the local signal, the at least one signal of the at least one cellular emitter or the at least one correlation result, based on the generated plurality of phasor sequences, to determine at least one phase-compensated correlation result; and
identifying a phasor sequence in the plurality of phasor sequences that optimizes the at least one motion compensated correlation result.

8. An apparatus for determining a legitimacy of at least one emitter, comprising:
at least one processor and at least one memory for storing programs and instructions that, when executed by the at least one processor, causes the apparatus to perform operations comprising:
receiving at least one signal from the at least one emitter at a respective antenna of at least one receiver;
determining a motion of the respective antenna of the at least one receiver that received the at least one signal from the at least one emitter;
using the determined antenna motion, performing motion compensated correlation on the at least one received signal to generate at least one motion compensated correlation result;
determining a direction of arrival for the at least one received signal using the at least one motion compensated correlation result;
determining a location of the at least one emitter using the direction of arrival of the at least one received signal and a known location of the at least one receiver; and
determining the legitimacy for the at least one emitter based on the determined location of the at least one emitter and received information regarding locations of legitimate emitters.

9. The apparatus of claim 8, wherein the apparatus further performs:
performing an action to affect a reception of signals from the at least one emitter at the at least one receiver based on the determined legitimacy of the at least one emitter.

10. The apparatus of claim 9, wherein the at least one emitter is determined to be legitimate and wherein the performed action comprises at least one of adjusting an antenna pattern of the respective antenna of the at least one receiver to increase a reception quality of the signals from the at least one emitter at the at least one receiver, adjusting a time of reception of the respective antenna of the at least one receiver to configure the respective antenna to receive signals during a time of transmission of the signals from the at least one emitter, or communicating a command to the at least one emitter to cause the at least one emitter to perform an action to increase a reception quality of the signals from the at least one emitter at the at least one receiver.

11. The apparatus of claim 9, wherein the at least one emitter is determined to be illegitimate and wherein the performed action comprises at least one of adjusting an antenna pattern of the respective antenna of the at least one receiver to decrease a reception quality of the signals from the at least one emitter at the at least one receiver, adjusting a time of reception of the respective antenna of the at least one receiver to prevent the respective antenna from receiving signals during a time of transmission of the signals from the at least one emitter, or communicating a command to the at least one emitter to cause the at least one emitter to perform an action to decrease a reception quality of the signals from the at least one emitter at the at least one receiver.

12. The apparatus of claim 8, wherein the determination of the legitimacy for the at least one emitter is further based on at least one characteristic of at least one of the at least one signal from the at least one emitter received at the respective antenna of the at least one receiver or the at least one emitter.

13. The apparatus of claim 12, wherein the at least one characteristic comprises at least one of a signal type of the at least one signal, an angle of arrival of the at least one signal, or positional information of the at least one emitter.

14. The apparatus of claim 8, wherein performing motion compensated correlation comprises:
correlating at least one local signal with the at least one signal from the at least one cellular emitter to generate at least one respective correlation result;
generating a plurality of phasor sequences, where each phasor sequence represents a hypothesis comprising a sequence of signal phases related to a relative direction of motion of the relative antenna of the at least one receiver;
compensating at least one phase of at least one of the local signal, the at least one signal of the at least one cellular emitter or the at least one correlation result, based on the generated plurality of phasor sequences, to determine at least one phase-compensated correlation result; and
identifying a phasor sequence in the plurality of phasor sequences that optimizes the at least one motion compensated correlation result.

15. A system for determining a legitimacy of at least one emitter, comprising:
at least one receiver comprising a respective antenna;
a motion module;
at least one emitter; and
an apparatus comprising at least one processor and at least one memory for storing programs and instructions that, when executed by the at least one processor, causes the apparatus to perform operations comprising:
receiving at least one signal from the at least one emitter at the respective antenna of the at least one receiver;
determining, using the motion module, a motion of the respective antenna of the at least one receiver that received the at least one signal from the at least one emitter;
using the determined antenna motion, performing motion compensated correlation on the at least one received signal to generate at least one motion compensated correlation result;
determining a direction of arrival for the at least one received signal using the at least one motion compensated correlation result;
determining a location of the at least one emitter using the direction of arrival of the at least one received signal and a known location of the at least one receiver; and
determining the legitimacy for the at least one emitter based on the determined location of the at least one emitter and received information regarding locations of legitimate emitters.

16. The system of claim 15, wherein the apparatus further performs:
performing an action to affect a reception of signals from the at least one emitter at the at least one receiver based on the determined legitimacy of the at least one emitter.

17. The system of claim 16, wherein the at least one emitter is determined to be legitimate and wherein the performed action comprises at least one of adjusting an antenna pattern of the respective antenna of the at least one receiver to increase a reception quality of the signals from the at least one emitter at the at least one receiver, adjusting a time of reception of the respective antenna of the at least one receiver to configure the respective antenna to receive signals during a time of transmission of the signals from the at least one emitter, or communicating a command to the at least one emitter to cause the at least one emitter to perform an action to increase a reception quality of the signals from the at least one emitter at the at least one receiver.

18. The system of claim 16, wherein the at least one emitter is determined to be illegitimate and wherein the performed action comprises at least one of adjusting an antenna pattern of the respective antenna of the at least one receiver to decrease a reception quality of the signals from the at least one emitter at the at least one receiver, adjusting a time of reception of the respective antenna of the at least one receiver to prevent the respective antenna from receiving signals during a time of transmission of the signals from the at least one emitter, or communicating a command to the at least one emitter to cause the at least one emitter to perform an action to decrease a reception quality of the signals from the at least one emitter at the at least one receiver.

19. The apparatus of claim 15, wherein the determination of the legitimacy for the at least one emitter is further based on at least one characteristic of at least one of the at least one signal from the at least one emitter received at the respective antenna of the at least one receiver or the at least one emitter, and wherein the at least one characteristic comprises at least one of a signal type of the at least one signal, an angle of arrival of the at least one signal, or positional information of the at least one emitter.

20. The system of claim 15, wherein performing motion compensated correlation comprises:
correlating at least one local signal with the at least one signal from the at least one cellular emitter to generate at least one respective correlation result;
generating a plurality of phasor sequences, where each phasor sequence represents a hypothesis comprising a sequence of signal phases related to a relative direction of motion of the relative antenna of the at least one receiver;
compensating at least one phase of at least one of the local signal, the at least one signal of the at least one cellular emitter or the at least one correlation result, based on the generated plurality of phasor sequences, to determine at least one phase-compensated correlation result; and
identifying a phasor sequence in the plurality of phasor sequences that optimizes the at least one motion compensated correlation result.
